(19) United States
(12) Patent Application Publication
(10) Pub. No.: US 2021/0023731 A1
(43) Pub. Date: Jan. 28, 2021

(54) TOOL AND METHOD FOR PRODUCING A BLANK FROM A CARDBOARD SHEET

(71) Applicant: MAYR-MELNHOF KARTON AG, Wien (AT)

(72) Inventor: Norbert GERBIG, Dietzenbach (DE)

(21) Appl. No.: 16/613,656

(22) PCT Filed: May 14, 2018
(86) PCT No.: PCT/EP2018/062326

§ 371 Date: Nov. 14, 2019

(30) Foreign Application Priority Data
May 16, 2017 (EP) 17171345.6

(51) Int. Cl. B26D 7/18

(52) U.S. Cl. CPC B26D 7/1863

(57) ABSTRACT

The invention relates to a tool for producing a blank from a cardboard sheet, having a first tool part with at least one cutting line contour, by means of which at least one scrap part is separable from the blank, and having a second tool part, which cooperates with the first tool part to separate the blank from the at least one scrap part. In order to be able to remove relatively small scrap parts from the punching process in a particularly quick and easy manner, at least one suction duct of a suction device is provided in the first tool part, the at least one scrap part being able to be extracted by suction via said suction duct. The invention furthermore relates to a method for producing a blank from a cardboard sheet.

The invention relates to a tool and to a method for producing a blank from a cardboard sheet according to the preambles of claims 1 and 10, respectively.

In producing blanks from cardboard sheets with a corresponding tool, which is usually formed as cutting, punching and/or grooving tools, smaller scrap parts are often separated from the blank by means of a corresponding cutting line contour—arranged at a first tool part. Therein, the first tool part as a female mold cooperates with a second tool part as a male mold, between which the respective cardboard sheet is arranged and the blank is generated by separating the at least one scrap part.

While large scrap can be relatively easily removed and transported away from the blank of the cut or punched cardboard sheet, heretofore, especially small punching scraps can be lost in further transport of the cardboard sheet, which can result in contaminations and further impairments in the production process.

From DE 100 65 457 A1, a method and a device for separating blank and scrap of a punched or cut material sheet are already known, in which the separation of blank and scrap is effected in a transport device, by means of which the blank and the scrap are removed from a processing device, in which cutting the cardboard sheet is effected. For separating blank and scrap, the transport device therein comprises multiple attraction surfaces with different attraction or suction forces to separate the respective cardboard parts and to remove the scrap from the process.

It is the object of the present invention to provide a tool and a method for producing a blank from a cardboard sheet, by means of which smaller scrap parts can be removed from the process in particularly simple and fast manner.

According to the invention, this object is solved by a tool and a method for producing a blank from a cardboard sheet having the features of claims 1 and 10, respectively. Advantageous configurations and beneficial developments of the invention are the subject matter of the dependent claims.

In order to provide a tool, by means of which smaller scrap parts can be removed from the process in particularly simple and fast manner, it is provided according to the invention that in the first tool part, in which the cutting line contour is arranged, at least one suction duct of a suction device is additionally provided, via which the at least one scrap part separated by means of the cutting line contour can be sucked off. Thus, according to the invention, it is provided to suck off respective small scrap parts immediately on site within the first tool part and immediately during the process step of punching the scrap part from the blank, respectively. Hereby, it is ensured in particularly simple and reliable manner that scrap parts cannot be lost in further transport of the sheet and in the further process, respectively, which otherwise could result in contaminations of the plant or in impairment of the process.

Therein, a corresponding suction duct can be relatively simply introduced into the corresponding tool part, namely in particular if it is composed of multiple support plates. Therein, the suction duct has to be only partially provided within the corresponding tool part. A guide of the duct partially arranged externally at the tool part, for example by means of corresponding lines, is also conceivable. Therein, it is a further advantage that the suction duct can be relatively simply connected to the corresponding suction device.

In further configuration of the invention, it has therein proven advantageous if the suction duct is formed by the cutting line contour at least over a length area. Thus, the cutting line contour forms the entry of the suction duct such that separated scarp parts can be immediately transported away from the cutting area to the rear into the corresponding tool part. Since the respective scrap part is thus inevitably pressed into the suction duct as a result of cutting, the suction is effected in particularly simple and reliable manner. In addition, the suction duct is particularly beneficially adapted to the corresponding scrap part in its shape such that a force generated as a result of suction acts on the scrap part in optimum manner.

A further advantageous configuration of the invention provides that the first tool part comprises at least one, in particular upper support plate, in which the suction duct is formed at least over a length area. Such a suction duct within the corresponding support plate can be particularly simply produced.

In further configuration of the invention, the first tool part comprises at least one, in particular lower support plate, in which the cutting line contour is accommodated. Thus, a recess continuous through the support plate can be provided for the cutting line contour in simple manner.

It has additionally proven advantageous if the first tool part comprises an intermediate plate, in which the suction duct is formed at least over a length area, between the support plate, in which the cutting line contour is accommodated, and the support plate, in which the suction duct is formed at least over a length area. Thus, the intermediate plate can serve for supporting the cutting line contour on the one hand and be provided with one or more suction ducts in simple manner on the other hand.

In further configuration of the invention, the suction duct is formed by respective partial suction ducts over a length area. These partial suction ducts can adjoin to respective circumferentially closed contour areas of the cutting line contour such that multiple scrap parts can be separated from the blank and sucked off via the respectively associated partial suction duct at the same time.

In further configuration of the invention, the cutting line contour comprises at least one circumferentially closed contour area for separating the respective scrap part, wherein the suction duct or partial suction duct respectively adjoining thereto is formed larger in cross-section than the associated contour area. By this, preferably slightly larger, cross-section of the respective suction duct or partial suction duct with respect to the respective contour area of the cutting line contour, it is achieved that the respectively separated scrap parts are removed from the cutting location without jamming within the suction duct or partial suction duct on the one hand, but with a sufficiently large suction force on the other hand.

An embodiment of the invention has additionally proven advantageous, in which the suction duct includes a final duct, which exits from the corresponding support plate towards both sides, wherein a suction element of the suction device is connected to the one side of the final duct and a free inflow opening is provided on the other side of the final duct. Such a final duct can be very simply produced on the one hand and opens the simple possibility of generating a continuous airflow for sucking off the scrap parts on the other hand.

Finally, it has proven advantageous to provide the final duct on an outer side of the corresponding support plate, at which a frame sheet is arranged. Hereby, the final duct can be particularly inexpensively generated.

The advantages mentioned above in connection with the tool according to the invention arise in exactly the same manner for the method for producing a blank from a cardboard sheet having the features of claim 10.

In an advantageous configuration of the method according to the invention, the suction duct is formed by respective partial suction ducts over a length area and the at least one scrap part is sucked off via at least one partial suction duct.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations without departing from the scope of the invention. Thus, implementations are also to be considered as encompassed and disclosed by the invention, which are not explicitly shown in the figures and explained, but arise from and can be generated by separated feature combinations from the explained implementations.

Below, an embodiment of the invention is explained in more detail based on the drawings. There show:

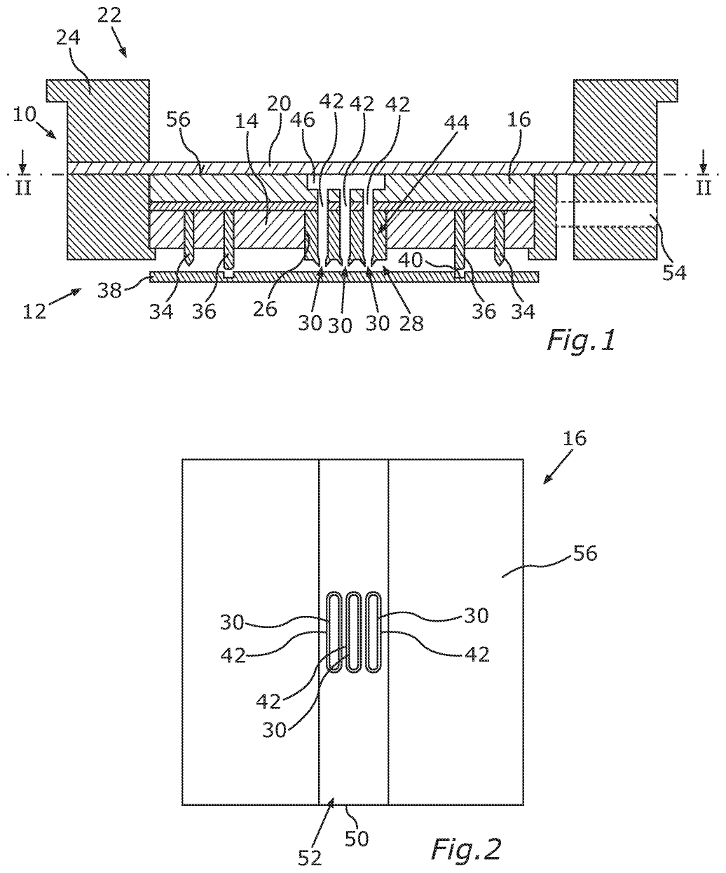

FIG. 1 a schematic sectional view to a tool for producing a blank from a cardboard sheet;

FIG. 2 a schematic plan view to an upper support plate of the first, upper tool part along a sectional plane represented by a line II-II in FIG. 1; and in

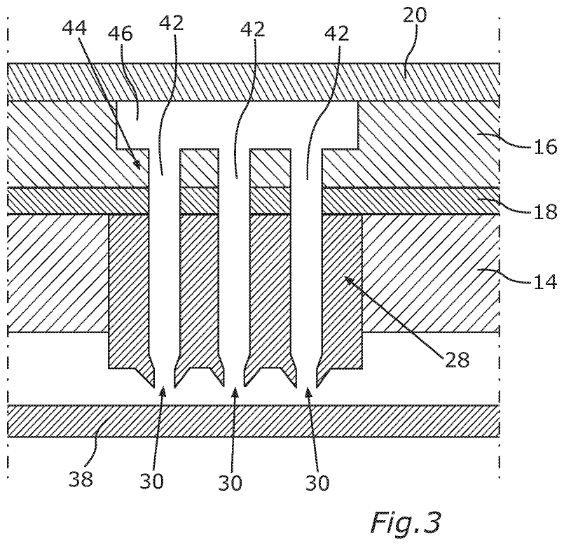

FIG. 3 a representation of the tool in the area of the cutting line contour in sections and enlarged with respect to FIG. 1.

In FIG. 1, a tool for producing a blank not illustrated from a cardboard sheet also not illustrated is shown in a schematic sectional view. The tool here formed as a combined cutting, punching and grooving tool basically includes a first, upper tool part 10 in the manner of a female mold and a lower tool part 12 in the manner of a male mold. Respective cardboard sheets for producing corresponding blanks in a continuous process can be introduced between the two tool parts 10, 12, wherein the separation of scrap parts and the introduction of folding grooves in a manner described in more detail below are effected by a relative movement of the two tool parts 10, 12 relative to each other, predominantly by moving the first tool part 10 relative to the second tool part 12. Presently, the tool is illustrated at least partially open.

The upper tool part 10 is composed of a lower support plate 14 and an upper support plate 16 with interposition of an intermediate plate 18. Moreover; a frame sheet 20 is provided on the upper side of the upper support plate 16. All of the plates 14 to 18 are accommodated and clamped with each other in a retaining device 22 with a lateral retaining frame 24.

In the present case, the lower support plate 14 is a multiplex support plate with a central, continuous recess 26, in which a cutting line contour 28 is inserted at least substantially identical in shape. Presently, the cutting line contour 28 is formed of a metal block and includes substantially three circumferentially closed contour areas 30, by means of which respective scrap parts (not illustrated) arranged parallel to each other are separable from the cardboard sheet or blank. Accordingly, of the cutting line contour 28, six cutting areas 32 of the corresponding cutting line are illustrated in the present sectional view. Towards the top, the metal block of the cutting line contour 28 terminates flush on the top side of the lower support plate 14 and on the bottom side of the intermediate plate 18, respectively, on which the cutting line contour 28 supports. For this reason among other things, the intermediate plate is configured of a steel material with a hardness of for example about 50 HRC.

Besides the central recess 26 for the cutting line contour 28, the lower support plate 14 includes further recesses for respective lateral cutting lines 34 for separating the blank from a large scrap part as well as a respective grooving line 36 arranged inside thereof for generating a folding groove in the blank.

The lower tool part 12 presently includes substantially a counter plate 38, which cooperates with the cutting line contour 28, the respective cutting line 34 and the respective grooving line 36 such that the desired cuts of the scrap parts and folding grooves arise. Hereto, corresponding grooves 40 for cooperation with the grooving lines 36 are provided in the counter plate 38.

Presently, to the three circumferentially closed contour areas 30 formed by the cutting line contour 28 for separating the respective scrap part, a suction duct 44 formed by the three partial suction ducts 42 in this area adjoins. The partial suction ducts 42 or the suction duct 44 formed hereby thus extend within the cutting line contour 28 towards the top up to the intermediate plate 18, in which the partial suction ducts 42 are continued identical in shape. Starting from the intermediate plate 18, the partial suction ducts 42 extend over a length area in vertical direction within the upper support plate 16 until they open into a final duct 46 of the suction duct 44.

Therein, the progression of the final duct 46—as well as the shape of the partial suction ducts 42—is particularly beneficially apparent from FIG. 2, which shows the upper support plate 16 in a schematic plan view along the sectional plane represented by the line II-II in FIG. 1. Herein, it in particular becomes apparent that the final duct 46 exits from the corresponding support plate 16 towards both sides 48, 50, wherein a non-illustrated suction element of a suction device is connected to the one side 48, 50 of the final duct 46, and a free inflow opening 52 is provided on the other side of the final duct 46. Therein, the suction element of the suction device is for example connected to a subsequent further suction duct 54 of the suction device, which extends in the retaining frame 24. Thus, a continuous suction airflow can be generated within the final duct 46 from the inflow opening 52 towards the suction element, thus from the one to the other side 48, 50 of the support element 16, by means of the suction device.

It is clear that the airflow within the final duct could be generated not only by suction, but also by blowing air in on the one side 48, 50. By such a blown-in airflow, thus, a suction effect of the suction device can also be achieved at the contour areas 30 of the cutting line contour 28 and within the partial suction ducts 42, respectively.

The force of this suction airflow furthermore acts over the partial suction ducts 42 until in the area of the respective contour areas 30 of the cutting line contour 28, by means of which the respective scrap parts are separated from the blank. Therein, the scrap parts are pressed into the partial suction ducts 42 in punching and cutting, respectively, and transported further upwards to the final duct 46 by the suction airflow, from where the further evacuation is effected via the suction device.

In order to achieve a particularly beneficial suction of the scrap parts—as it is in particular apparent from FIG. 3 based on a sectional representation of the tool enlarged with respect to FIG. 1 in the area of the cutting line contour 28—the partial suction ducts 42 are formed larger in cross-section than the associated contour areas 30 of the cutting line contour 28. For this reason, double lines are also apparent in the area of the partial suction ducts 42 in the plan view of FIG. 2, since a respectively inner line shows the respective contour area 30 of the cutting line contour 28.

In synopsis of FIGS. 1 and 2, it is additionally apparent that the final duct 46 is provided on an outer side 56 of the corresponding support plate 16. Thus, it can be particularly simply produced in that it is closed by the frame sheet 20 towards the top. The upper support plate 16 is presently formed of an aluminum alloy, which allows simple processing.

Thus, it is overall apparent that a method can presently be provided, in which at least one scrap part can be separated from the blank with the cutting line contour 28 of the first tool part 10 by cooperation with the second tool part 12, which is herein pressed to the rear and to the top into the corresponding partial suction duct 42, respectively, and is sucked off from here via the suction duct 44.

The present tool can in particular be employed for processing material sheets of paper or cardboard in thicknesses between 80 g/m² and 500 g/m² or with a material thickness between about 80 μm and 700 μm, Herein, the material sheets can in particular also be both printed and varnished and coated with a polymer layer or with a plastic film. Similarly, the material sheets can have a coating with a metal film, for example of an aluminum material, Of course, combinations of the described materials can also be employed in a corresponding material sheet. Finally, the material sheets can also be formed of a laminate or have a composite structure.

### LIST OF REFERENCE CHARACTERS

10 tool part
12 tool part
14 lower support plate
16 upper support plate
18 intermediate plate
20 frame sheet
22 retaining device
24 retaining frame
26 recess
28 cutting line contour
30 contour area
32 cutting area
34 cutting line
36 grooving line
38 counter plate
40 grooves
42 partial suction ducts
44 suction duct
46 final duct
48 side
50 side
52 inflow opening
54 suction duct
56 outer side

1. A tool for producing a blank from a cardboard sheet comprising:
a first tool part with at least one cutting line contour, by means of which at least one scrap part is separable from the blank, and
a second tool part, which cooperates with the first tool part for separating the blank from the at least one scrap part, wherein
at least one suction duct of a suction device is provided in the first tool part, via which the at least one scrap part can be sucked off.

2. The tool according to claim 1, wherein the suction duct is formed by the cutting line contour at least over a length area.

3. The tool according to claim 1, wherein the first tool part comprises at least one support plate, in which the suction duct is formed at least over a length area.

4. The tool according to claim 3, wherein the first tool part comprises at least one support plate, in which the cutting line contour is accommodated.

5. The tool according to claim 4, wherein the first tool part comprises an intermediate plate, in which the suction duct is formed at least over a length area, between the support plate in which the cutting line contour is accommodated, and the support plate in which the suction duct is formed at least over a length area.

6. The tool according to claim 1, wherein the suction duct is formed by respective partial suction ducts over a length area.

7. The tool according to claim 6, wherein the cutting line contour comprises at least one circumferentially closed contour area for separating a respective scrap part, wherein the suction duct or partial suction duct respectively adjoining thereto is formed larger in cross-section than the associated contour area.

8. The tool according to claim 3, wherein the suction duct includes a final duct, which exits from the corresponding support plate towards both sides, wherein a suction element of the suction device is connected to the one side of the final duct and a free inflow opening is provided on the other side of the final duct.

9. The tool according to claim 8, wherein the final duct is arranged on an outer side of the corresponding support plate, at which a frame sheet is arranged.

10. A method for producing a blank from a cardboard sheet by means of a tool, in which at least one scrap part is separated from the blank with a cutting line contour of a first tool part by cooperation with a second tool part, wherein the at least one scrap part is sucked off via at least one suction duct of a suction device provided in the first tool part.

11. The method according to claim 10, wherein the suction duct is formed by respective partial suction ducts via a length area and the at least one scrap part is sucked off via at least one partial suction duct.
